(19) United States
(12) Patent Application Publication
(10) Pub. No.: US 2025/0004166 A1
(43) Pub. Date: Jan. 2, 2025

(54) TECHNIQUES FOR DETERMINING LIGHTNING THREATS TO ENERGY INFRASTRUCTURE AND OPERATIONS

(71) Applicant: Utopus Insights, Inc., Valhalla, NY (US)

(72) Inventor: Aijun Deng, White Plains, NY (US)

(73) Assignee: Utopus Insights, Inc., Valhalla, NY (US)

(21) Appl. No.: 18/399,538

(22) Filed: Dec. 28, 2023

Related U.S. Application Data
(60) Provisional application No. 63/524,620, filed on Jun. 30, 2023.

(51) Int. Cl. G01W 1/10; G08B 21/10

(52) U.S. Cl. CPC G01W 1/10; G08B 21/10

(57) ABSTRACT

Example systems, methods, and non-transitory computer readable media are directed to determining a geographic site to be assessed for lightning activity over a period of time; obtaining weather information associated with the geographic site, the weather information being generated by a weather prediction model for the period of time, wherein the weather information comprises a grid-based representation of a weather map; determining one or more grid points to assess the geographic site for lightning activity; evaluating weather-related metrics associated with the one or more grid points; determining one or more likelihoods of the geographic site experiencing lightning activity during the period of time based at least in part on the evaluation; and providing weather forecast information for the geographic site, the weather forecast information including at least the one or more likelihoods of the geographic site experiencing lightning activity during the period of time.

### CROSS-REFERENCE TO RELATED APPLICATIONS

This application claims priority to and seeks the benefit of U.S. Provisional Patent Application No. 63/524,620, filed on Jun. 30, 2023, and entitled “Systems and Methods for Lightning Prediction,” which is incorporated in its entirety herein by reference.

### FIELD OF THE INVENTION(S)

Embodiments of the present inventions relate generally to techniques for determining lightning threats to energy infrastructure and operations.

### BACKGROUND

Lightning strikes may adversely affect various types of infrastructures—especially those involving renewable energy production. For instance, wind turbines, due to their towering presence, are particularly susceptible to direct lightning hits. Such strikes may cause damage to turbine blades or electronic components housed within the wind turbines. In another example, solar farms, which are often spread out across large open areas, are susceptible to lightning strikes that may damage panels, inverters, and associated electronics. Further, dams and hydropower structures also face threats from lightning, primarily concerning their electronic and control systems. Additionally, biomass or biogas stored at bioenergy production facilities are susceptible to fires that may be triggered by lightning strikes.

In addition to potentially compromising infrastructure, lightning strikes may also be disruptive to operations. For instance, the presence of lightning may be a significant hazard to personnel who work in unsheltered environments, such as energy farms. As an example, personnel tasked with maintaining renewable energy infrastructure, such as wind turbines, may be at risk of injury or death should lightning activity develop during such maintenance. In another example, lightning may impact agricultural farm operations by posing risks to property, livestock, and crops.

### SUMMARY

Example systems, methods, and non-transitory computer readable media are directed to determining a geographic site to be assessed for lightning activity over a period of time; obtaining weather information associated with the geographic site, the weather information being generated by a weather prediction model for the period of time, wherein the weather information comprises a grid-based representation of a weather map, and wherein grid points in the grid-based representation of the weather map are associated with respective weather-related metrics generated by the weather prediction model; determining one or more grid points from the grid-based representation of the weather map to assess the geographic site for lightning activity; evaluating weather-related metrics associated with the one or more grid points determined for assessing the geographic site; determining one or more likelihoods of the geographic site experiencing lightning activity during the period of time based at least in part on the evaluation of the weather-related metrics associated with the one or more grid points; and providing weather forecast information for the geographic site, the weather forecast information including at least the one or more likelihoods of the geographic site experiencing lightning activity during the period of time.

According to some embodiments, weather-related metrics associated with a grid point in the grid-based representation of the weather map are predicted by the weather prediction model for a geographic location corresponding to the grid point, and the weather-related metrics include at least one of: one or more lightning flash density values predicted for the grid point, one or more Convective Available Potential Energy (CAPE) values predicted for the grid point, one or more Convective Rain Rate (CRR) values predicted for the grid point, or one or more K-index values predicted for the grid point.

According to some embodiments, determining the one or more grid points from the grid-based representation of the weather map to assess the geographic site for lightning activity comprises: identifying one or more grid points in the grid-based representation of the weather map that are positioned within a threshold distance of the geographic site.

According to some embodiments, determining the one or more grid points from the grid-based representation of the weather map to assess the geographic site for lightning activity comprises: determining a plurality of grid points in the grid-based representation of the weather map that encompass the geographic site based at least in part on a bounding shape.

According to some embodiments, evaluating weather-related metrics associated with the one or more grid points determined for assessing the geographic site comprises: determining an explicit prediction based at least in part on weather-metrics associated with the one or more grid points determined for assessing the geographic site for lightning activity, the explicit prediction being based at least in part on lightning flash density values associated with the one or more grid points; and determining an implicit prediction based at least in part on weather-metrics associated with the one or more grid points determined for assessing the geographic site for lightning activity, the implicit prediction being based at least in part on one or more of: Convective Available Potential Energy (CAPE) values associated with the one or more grid points determined for assessing the geographic site, Convective Rain Rate (CRR) values associated with the one or more grid points determined for assessing the geographic site, or K-index values associated with the one or more grid points determined for assessing the geographic site.

According to some embodiments, the explicit prediction is calculated as a fraction with a numerator that corresponds to a count of grid posts in the one or more grid posts that have a non-zero lightning flash density value and a denominator that corresponds to a total count of grid posts in the one or more grid posts.

According to some embodiments, the implicit prediction is calculated as a weighted average of at least one of: Convective Available Potential Energy (CAPE) values associated with the one or more grid points determined for assessing the geographic site, Convective Rain Rate (CRR) values associated with the one or more grid points determined for assessing the geographic site, or K-index values associated with the one or more grid points determined for assessing the geographic site.

According to some embodiments, a likelihood of the geographic site experiencing lightning activity during the period of time is calculated as a weighted average of one or more values associated with the explicit prediction and one or more values associated with the implicit prediction.

According to some embodiments, providing weather forecast information for the geographic site comprises: determining that at least one of the one or more likelihoods of the geographic site experiencing lightning activity during the period of time satisfy a threshold likelihood value; and providing an alert to a computing system associated with the geographic site in response to the determination.

According to some embodiments, providing weather forecast information for the geographic site comprises: providing a graphical user interface corresponding to a weather monitoring platform, the graphical user interface including at least: a visual map of the geographic site and lightning information determined for the geographic site.

Example systems, methods, and non-transitory computer readable media are directed to determining a geographic site to be assessed for lightning activity at point in time; obtaining weather information associated with the geographic site, wherein the weather information is forecasted by a weather prediction model for the point in time; determining at least one grid point in a grid-based representation of the weather information to assess the geographic site for lightning activity; determining lightning information for the geographic site based at least in part on an evaluation of weather-related metrics associated with the at least one grid point, wherein the lightning information forecasts lightning activity for the geographic site at the point in time; and providing lightning information for the geographic site, wherein the lightning information includes at least information describing lightning activity forecasted for the geographic site at the point in time.

According to some embodiments, when determining at least one grid point in a grid-based representation of the weather information to assess the geographic site for lightning activity, the systems, methods, and non-transitory computer readable media are directed to identifying one or more grid points in the grid-based representation of the weather information that are positioned within a threshold distance of the geographic site.

According to some embodiments, when determining at least one grid point in a grid-based representation of the weather information to assess the geographic site for lightning activity, the systems, methods, and non-transitory computer readable media are directed to determining a plurality of grid points in the grid-based representation of the weather information that bound the geographic site based at least in part on a bounding shape.

According to some embodiments, when determining lightning information for the geographic site, the systems, methods, and non-transitory computer readable media are directed to determining a likelihood of lightning activity occurring at the geographic site at the point in time based at least in part on an evaluation of (a) lightning flash density values associated with the at least one grid point at the point in time, (b) Convective Available Potential Energy (CAPE) values associated with the at least one grid point at the point in time; (c) Convective Rain Rate (CRR) values associated with the at least one grid point at the point in time, or (d) K-index values associated with the at least one grid point at the point in time, or a combination thereof.

According to some embodiments, the lightning information includes the likelihood of lightning activity occurring at the geographic site at the point in time.

### BRIEF DESCRIPTION OF THE DRAWINGS

FIG. 1 depicts an example of a weather forecast provided by a numerical weather prediction (NWP) model.

FIG. 2A depicts an example environment according to some embodiments.

FIG. 2B depicts a block diagram of components of a lightning predictor system according to some embodiments.

FIGS. 3A-3E depict diagrams of an example approach for determining lightning activity for a geographic location according to some embodiments.

FIG. 4 depicts an example approach for determining lightning activity for a geographic location according to some embodiments.

FIG. 5 depicts an example graphical user interface according to some embodiments.

FIG. 6A illustrates an example process according to some embodiments.

FIG. 6B illustrates another example process according to some embodiments.

FIG. 7 is a block diagram illustrating a computing (or digital) device in one example.

### DETAILED DESCRIPTION

Given the many risks posed by lightning, there exists a need for early detection of weather conditions that trigger lightning strikes. Such advanced detection of lightning strikes may help provide extra time to prepare and, ultimately, mitigate damage to energy infrastructure and operations. For example, early detection of lightning strikes may help energy producers take precautions and implement safety shutdowns of energy infrastructure, such as wind turbines, to prevent or reduce damage to mechanical and electronic components. As another example, early detection of lightning strikes may facilitate energy infrastructure operations by allowing operators to efficiently schedule builds of new energy producing resources, or maintenance of existing ones, around hazardous weather conditions, thereby helping reduce or avoid injury to individuals while mitigating or preventing harm to energy infrastructure.

Other types of infrastructure and operations may also benefit from early warnings of lightning strikes. For example, agricultural farms, which may incorporate renewable energy operations, may benefit by coordinating work operations around hazardous weather conditions to avoid risk of injury to workers. As another example, animals in open fields may be at risk during thunderstorms. In such instances, early lightning warnings may allow farmers to move livestock to shelter. In yet another example, early lightning warnings can prompt deployment of protective measures to mitigate crop damage.

In general, lightning occurs in or in the vicinity of thunderstorms associated with atmospheric convection triggered by atmospheric instability and surface inhomogeneity. Conventional approaches for detecting such weather activity often come with limitations in terms of accuracy and geographic coverage. For example, lightning detection systems including sensor-based devices may be deployed at a geographic location (e.g., a renewable energy farm) to warn of lightning strikes. Such systems typically may detect electromagnetic signals produced by lightning to provide nearly real-time information about the location and intensity of lightning strikes. However, deployment of such lightning detection capabilities is not ideal or feasible for many geographic locations, whether due to prohibitive cost or geographic terrain. Accordingly, sensor-based solutions are not practical when monitoring lightning strikes on a global scale.

Another existing approach for predicting lightning involves use of numerical weather prediction (NWP) models. NWP models are complex computer models that simulate atmospheric changes to predict formation of weather systems, such as lightning activity.

One such NWP model is the European Centre for Medium-Range Weather Forecasts (ECMWF) HRES. The ECMWF HRES model may be capable of providing medium-range forecasts days in advance with a horizontal resolution of about 9 kilometers (km). This means that the ECMWF HRES model calculates weather data based on grid points that are spaced approximately 9 kilometers apart. The vertical resolution of the model is also quite high, with multiple layers that provide a detailed vertical profile of the atmosphere.

While useful to some extent, NWP models, such as ECMWF HRES, are generally incapable of resolving atmospheric convection—a weather condition associated with lightning strikes—that usually occurs on a much smaller spatial scale at around 3 to 4 km in diameter. Typically, the explicit lightning product (e.g., lightning flash density) from these coarse grid models are estimated or parameterized from unresolvable weather parameters or directly from convective parameters, such as convective cloud hydrometeors. In practice, lightning predictions from such coarse grid models are typically inaccurate.

Although higher resolution NWP models exist, such as the National Oceanic and Atmospheric Administration's (NOAA) High-Resolution Rapid Refresh (HRRR) model, these models are limited to partial resolution of atmospheric convection, which means lightning predictions from these models is also inaccurate and uncertain. In addition, such higher resolution NWPs are often limited to localized geographic regions, and thus cannot be used to accurately predict lightning strikes on a global scale.

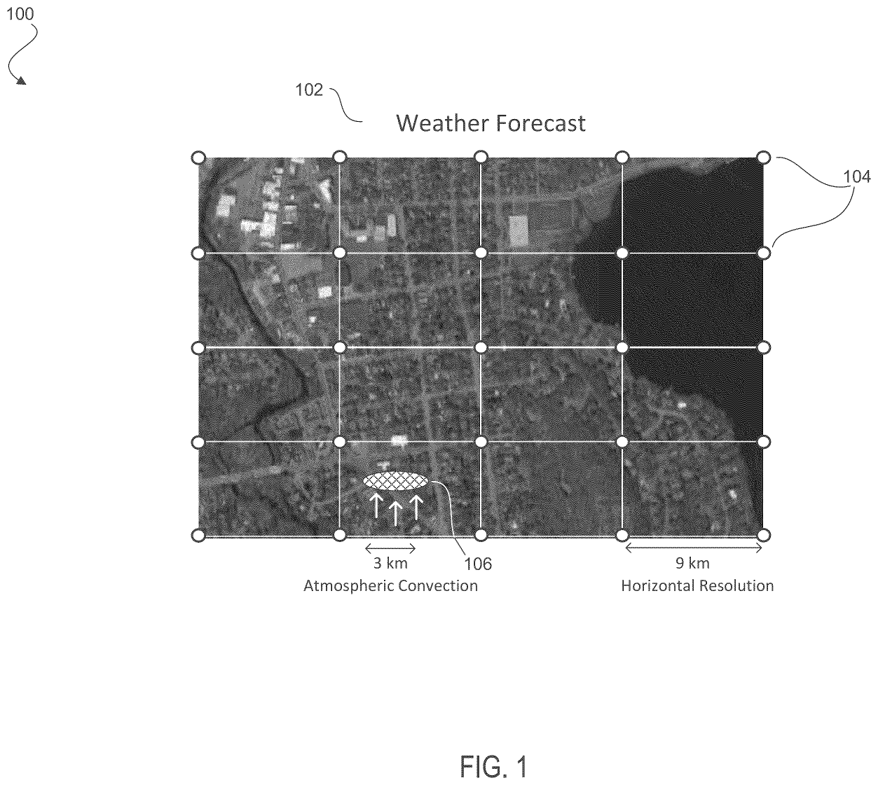

For example, FIG. 1 illustrates an example 100 of a weather forecast output 102 from an NWP model for a geographic region. The output 102 provides weather forecast information for the geographic region on a grid 104 with each cell having a horizontal resolution of 9 km. In this example, atmospheric convection 106 that may develop into lightning strikes may go undetected, since such convective activity generally occurs at a spatial scale (e.g., 3-4 km) that is much less than the 9 km horizontal resolution supported by the NWP model. As a result, the NWP model may poorly predict thunderstorms and lightning strikes, and thus fail to provide adequate and timely notice of such harmful weather conditions. Accordingly, methods for accurately predicting lightning strikes on a global scale are desirable from the viewpoint of owners and operators of various types of infrastructure, and especially energy producing farms, deployed throughout the world.

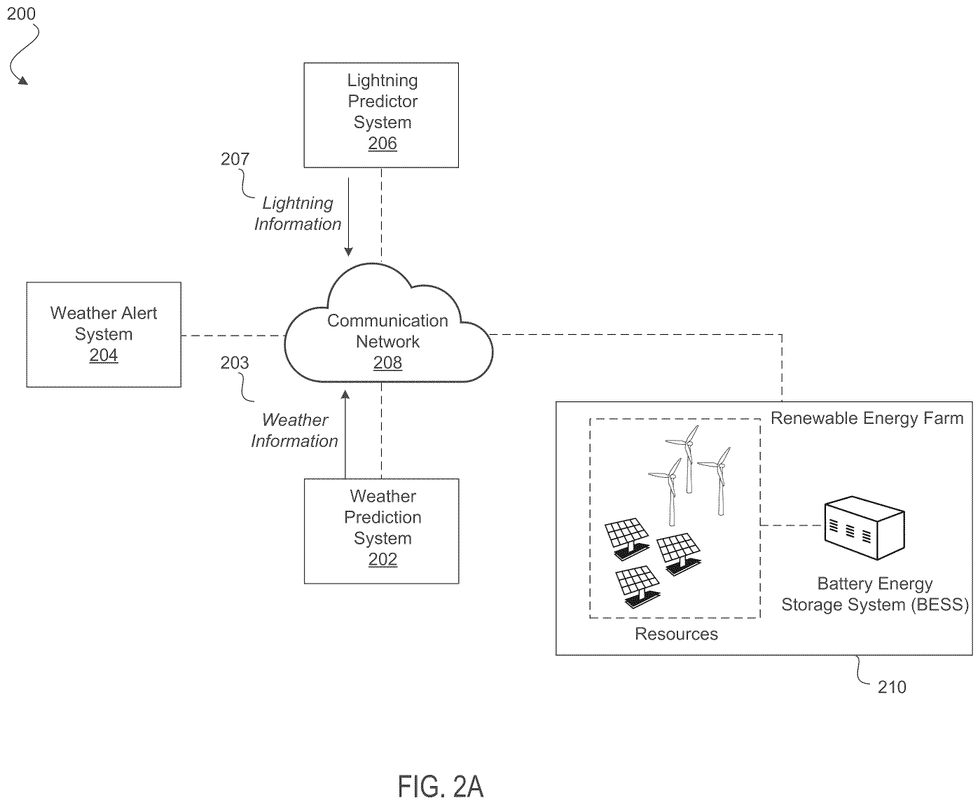

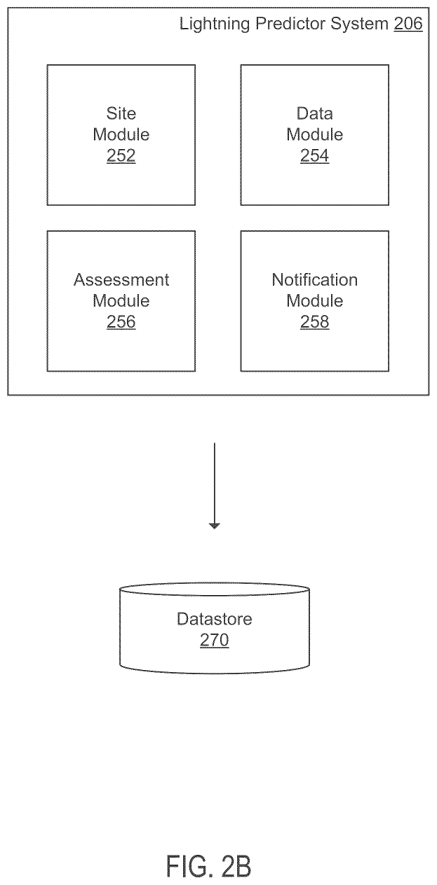

FIG. 2A is an example environment 200 according to some embodiments. The example embodiment includes a weather prediction system 202, a weather alert system 204, a lightning predictor system 206, and a communication network 208. The weather prediction system 202, the weather alert system 204, and the lightning predictor system 206 may communicate electronically with one another over the communication network 208. In various embodiments, the lightning predictor system 206 may receive or retrieve weather information 203 from the weather prediction system 202, which may include any number of models, forecasts, and/or predictions corresponding to geographic locations. The lightning predictor system 206 may receive and/or retrieve the weather information 203 to determine lightning information 207 for geographic locations throughout the world and at various levels of granularity.

In one example, the weather prediction system 202 may provide weather information 203 (e.g., weather models, forecasts, predictions, etc.) produced by a weather forecasting entity, such as the European Centre for Medium-Range Weather Forecasts (ECMWF). The weather information 203 may be generated based on weather data received from any number of satellites, drones, sensors, aircraft, weather stations, and the like. For example, the weather information 203 may comprise a grid-based representation of a geographic location that is being assessed for lightning activity. In this example, each grid point may be associated with any number of weather-related metrics which are predicted by a weather model, such as the High Resolution Forecast (HRES) model, based on weather data received from satellites, drones, sensors, aircraft, weather stations, and the like. The HRES model may provide predictions of weather-related metrics for geographic locations at a horizontal resolution of 9 km. Further, the weather-related metrics may be predicted for different points in time (e.g., hourly, daily, etc.) over some time interval (e.g., 10 days, 15 days, etc.).

For example, the weather information 203 provided by the weather prediction system 202 may include atmospheric predictions, such as temperature, wind speed and direction, humidity, and surface pressure. As another example, the weather information 203 may include forecasts for different types of precipitation, distinguishing between rain, snow, and ice, and predictions on an amount and timing of precipitation. As further examples, the weather information 203 may include cloud information (e.g., cloud type, altitude, etc.), ocean and sea variables (e.g., temperatures, ocean currents, etc.), and tropospheric and stratospheric data.

While the examples herein refer to ECMWF and the HRES model, the techniques described herein may be used with any comprehensive weather prediction model which produces either deterministic or ensemble forecasts for geographic areas worldwide, such as the Global Forecast System (GFS) managed by the United States' National Weather Service (NWS), the UK Met Office Model managed by the UK Met Office (UKMO), or the Action de Recherche Petite Echelle Grande Echelle (ARPEGE) managed by Météo-France, to name some examples.

In the example of FIG. 2A, the weather prediction system 202 provides weather information 203 for a geographic site 210 (e.g., point of interest, location, region, etc.) corresponding to a renewable energy farm. For example, the geographic site 210 may correspond to a location over which the atmospheric convection 106 activity is occurring in FIG. 1. The renewable energy farm may employ various renewable energy infrastructure, such as wind farms, solar farms, hydropower structures, or bioenergy production facilities, to name some examples.

The lightning predictor system 206 may receive or retrieve the weather information 203 from the weather prediction system 202 to predict lightning activity for the geographic site 210. In some embodiments, the lightning predictor system 206 may provide more accurate lightning predictions and in more places around the globe than existing weather prediction systems or models. For example, the lightning predictor system 206 may generate lightning information 207 for the geographic site 210 based on the weather information 203 provided by the weather prediction system 202. The lightning information 207 may comprise various lightning-related metrics including a likelihood of lightning activity expected for the geographic site 210 over some window (or period) of time and time interval.

In various embodiments, the lightning predictor system 206 may apply a hybrid approach to determine the lightning information 207 for the geographic site 210. According to the hybrid approach, the lightning predictor system 206 may obtain both explicit and implicit predictions (or parts) from the weather information 203 for the geographic site 210.

In some embodiments, the explicit prediction of the hybrid approach may correspond to lightning flash density values associated with the geographic site 210.

As background, lightning flash density is a measure used to quantify the frequency of lightning occurrence over a specific area and time period. Lightning flash density may be expressed as the number of lightning flashes per square kilometer per year (flashes/km²/year). The lightning flash density is often useful for various applications, including weather forecasting and for designing structures and electrical systems to withstand lightning strikes. Lightning flash density may be calculated by counting the number of lightning flashes, including cloud-to-ground flashes and intra-cloud flashes, observed over a certain area and time period, and then normalizing this count by the area and the duration of observation. The resulting number gives a quantitative measure of how often lightning occurs in that area.

The implicit prediction of the hybrid approach may correspond to any number of metrics that measure weather conditions capable of producing thunderstorms. For example, in some embodiments, the implicit prediction of the hybrid approach comprises values corresponding to Convective Available Potential Energy (CAPE), Convective Rain Rate (CRR), and the K-index, either together or in some permutation thereof. In this example, the lightning predictor system 206 may evaluate CAPE, CRR, and K-index values corresponding to the geographic site 210. In general, the CAPE, CRR, and K-index values may be evaluated and combined in any way, depending on the embodiment. For example, in an embodiment, the implicit prediction comprises a weighted average of the CAPR, CRR and K-index corresponding to some or all of the grid points associated with the geographic site 210. Many variations are possible.

As background, CAPE, is a measure of the amount of energy available in the atmosphere for convection. Convection refers to the vertical movement of air masses, which can lead to the formation of clouds and potentially thunderstorms. CAPE is a measure of instability in the atmosphere. The more unstable the atmosphere, the higher the CAPE value tends to be. Instability in this context means that if an air parcel is given a nudge upward—for example, by surface heating, a front, or a mountain—it will continue to rise on its own because it is buoyant. This buoyancy is what drives strong updrafts that are characteristic of severe thunderstorms. In general, CAPE may be determined by integrating the amount of work done on an air parcel as it is lifted from the level of free convection (LFC)—the altitude at which it becomes buoyant—to the equilibrium level (EL)—the altitude at which the air parcel's density matches that of the surrounding air and it stops rising. The value of CAPE may be given in joules per kilogram (J/kg). In practical terms, higher CAPE values (typically above 1000 J/kg) suggest the potential for more vigorous convection and stronger storms, possibly producing severe weather phenomena such as large hail, damaging winds, and tornadoes.

CRR refers to the intensity of rainfall that is produced by convective processes in the atmosphere. Convective rain is generally associated with thunderstorms and showers, where the rainfall can be intense and often occurs over a relatively short period of time and covers a smaller area compared to stratiform or widespread rain. Convective rain may be generated by the vertical movement of air, driven by thermal buoyancy. When warm, moist air rises, it cools and condenses to form clouds and, under the right conditions, precipitation. The rate of this precipitation is what's referred to as the Convective Rain Rate. This rate can vary significantly, from light showers to torrential downpours associated with severe thunderstorms. The CRR may be measured in millimeters per hour (mm/h) and can be detected and estimated using weather radars and satellite observations. Areas of convective activity may be identified by looking at the intensity and movement of cloud formations, particularly those that are tall and have a lot of vertical development, which are indicative of convective storms. In general, the CRR may be an important metric for weather forecasting and hydrological modeling, as it helps in predicting the amount of rainfall that may be expected from convective clouds, aiding in flood forecasting and the management of water resources. CRR may also play a role in short-term weather prediction, especially for issuing warnings related to severe weather events that can result in high rainfall rates and subsequent flash flooding.

The K-index is a meteorological index used to estimate the potential for thunderstorm development, particularly the risk of convective weather events, such as thunderstorms that may be accompanied by lightning and turbulence. The K-index may be calculated using a set of temperature and dew point readings taken at various atmospheric pressure levels. The K-index may be based on the temperature difference between the 850 hPa (approximately 1.5 km above sea level) and 500 hPa (approximately 5.5 km above sea level) levels, which helps to assess the lapse rate or the rate at which temperature decreases with height. A larger temperature difference indicates a more unstable atmosphere, which is conducive to convection. Further, the K-index may be based on the temperature difference between the 700 hPa level (approximately 3 km above sea level) and the dew point at the same level, to evaluate the moisture content of the mid-troposphere. Lower differences (higher dew points) suggest more moisture is available, which can fuel thunderstorm development. In general, higher K-index values suggest greater potential for thunderstorms.

The weather alert system 204 may receive or retrieve information provided by the weather prediction systems 202 and the lightning predictor system 206, such as the weather information 203 and the lightning information 207. In various embodiments, the weather alert system 204 may provide a weather monitoring platform through which end-users, such as an operator of the renewable energy farm 210, may access the weather information 203 and the lightning information 207. For example, the weather alert system 204 may provide interfaces (e.g., graphical user interfaces, application programming interfaces, etc.) that allow end-users to access such weather-related information for any given geographic area. The interfaces may also be configured to provide alerts and/or instructions when, based on the lightning information 207, the geographic site 210 has a threshold likelihood of experiencing lightning strikes.

In some embodiments, the weather alert system 204 may be programmed to provide weather alerts to computing systems of end-users over the communication network 208 when a geographic site has a threshold likelihood of experiencing lightning strikes. The weather alerts may provide sufficient notice to allow such end-users to take precautions to avoid or mitigate damage that may occur to infrastructure and/or operations due to lightning activity.

In some embodiments, the weather alert system 204 may be programmed to provide shutdown instructions to computing systems of end-users over the communication network 208 when a geographic site has a threshold likelihood of experiencing lightning strikes. For example, the weather alert system 204 may provide shutdown instructions to a computing system associated with the geographic site. In response to the shutdown instructions, the end-user computing systems may be configured to automatically initiate procedures to shut down infrastructure to avoid or mitigate damage that may occur due to lightning activity. For example, based on the shutdown instructions, a computing system associated with the geographic site may shut down energy infrastructure, such as wind turbines, and related electronics to prevent or mitigate damage that may occur from an impending thunderstorm. Many variations are possible.

Depending on the embodiment, the weather alert system 204 and the lightning predictor system 206 may be configured to operate as individual systems or as a single system. For example, in some embodiments, the weather alert system 204 operates separately from the lightning predictor system 206. In such embodiments, the lightning predictor system 206 provides the lightning information 207 to the weather alert system 204. Further, the weather alert system 204 may provide end-users with access to the lightning information 207 through one or more interfaces (e.g., graphical user interfaces, application programming interfaces, etc.). In other embodiments, the weather alert system 204 and the lightning predictor system 206 operate as a single system that is capable of performing operations associated with both the weather alert system 204 and the lightning predictor system 206. In such embodiments, the system may both determine the lightning information 207 and provide end-users with access to the lightning information 207, including any weather alerts or instructions, through one or more interfaces (e.g., graphical user interfaces, application programming interfaces, etc.).

The weather prediction system 202, weather alert system 204, and lightning predictor system 206 may each be digital devices. A digital device is any device with a processor and memory. In some embodiments, communication network 208 represents one or more computer networks (e.g., LAN, WAN, and/or the like). The communication network 208 may provide communication between the weather prediction system 202, the weather alert system 204, the lightning predictor system 206, and a computing system of the renewable energy farm 210. In some implementations, the communication network 208 comprises computer devices, routers, cables, and/or other network topologies. In some embodiments, the communication network 208 may be wired and/or wireless. In various embodiments, the communication network 208 may comprise the Internet, one or more networks that may be public, private, IP-based, non-IP based, and so forth.

FIG. 2B is a block diagram of an example lightning predictor system 206 in some embodiments. The lightning predictor system 206 includes a site module 252, a data module 254, an assessment module 256, and a notification module 258.

The site module 252 may be configured to determine one or more geographic sites (e.g., points of interest, locations, regions, etc.) to be assessed for lightning activity. For example, the site module 252 may provide one or more interfaces (e.g., graphical user interfaces, application programming interfaces, etc.) through which geographic sites may be specified. In one example, a user may provide geographic coordinates using such interfaces. The geographic coordinates may identify a particular location of interest, such as the geographic site 210. As another example, a user may provide multiple geographic coordinates that define a bounding shape which encompasses a particular region of interest. In yet another example, users may identify (or select) geographic sites in a visual geographic map shown within a graphical user interface provided by the site module 252. Naturally, many variations are possible. For instance, a geographic site may be specified by providing a physical address to the site module 252. It will be appreciated that the geographic sites may correspond to any type of location or region to be monitored for purposes of determining lightning information (e.g., assessments, reports, and/or alerts).

In general, any number of users (e.g., an individual, a group of users, an organization, a corporation, and/or the like) may create accounts with the lightning predictor system 206 for purposes of monitoring geographic sites for lightning activity. A user may identify one or more geographic sites to be monitored for lightning activity. Information describing the identified geographic sites (e.g., geographic coordinates, bounding shapes, etc.) may be stored by the lightning predictor system 206, for example, in a data store 270.

Users may also be able to customize the monitoring of their specified geographic sites. In some embodiments, the site module 252 may provide options to customize a window of time over which lightning information (e.g., assessments, reports, and/or alerts) may be provided. In one example, one user may request lightning information for one or more geographic sites over a 10-day window of time. Another user may request lightning assessments for one or more geographic sites over a 6-day window of time. It will be appreciated that users may request different windows of time for different geographic sites.

In some embodiments, a user may define time intervals at which lightning information should be determined for a given geographic site. For example, a user may request hourly lightning information for a geographic site. In another example, a user may request lightning information be determined for one geographic site on an hourly basis and lightning information be determined for another geographic site every six hours. Naturally, different users may request different time intervals for determining lightning information.

The data module 254 may be configured to receive or retrieve weather information from any number of weather prediction systems 202. The weather information may be received or retrieved periodically and automatically based on settings determined by the site module 252, such as a specified geographic location, window of time, and time interval. The weather information may be used by the assessment module 256 to determine lightning information (e.g., assessments, reports, and/or alerts) for geographic sites, such as the geographic site 210.

The weather information may include weather models, predictions, and/or forecasts for geographic areas across the world. For example, the data module 254 may access the HRES model provided by ECMWF or the GFS weather prediction model provided by NWS. The lightning information may comprise various lightning-related metrics, including likelihoods of lightning activity expected for a geographic site over some time interval. As mentioned, the techniques described herein are not limited to a particular model and may be applied to weather information that may be provided by any comprehensive weather model.

The assessment module 256 may be configured to determine lightning information for geographic sites based on weather information obtained by the data module 254.

In various embodiments, the assessment module 256 may apply a hybrid approach to determine lightning information for a geographic site. According to the hybrid approach, the assessment module 256 evaluates both explicit and implicit weather model predictions (or parts) associated with the geographic site.

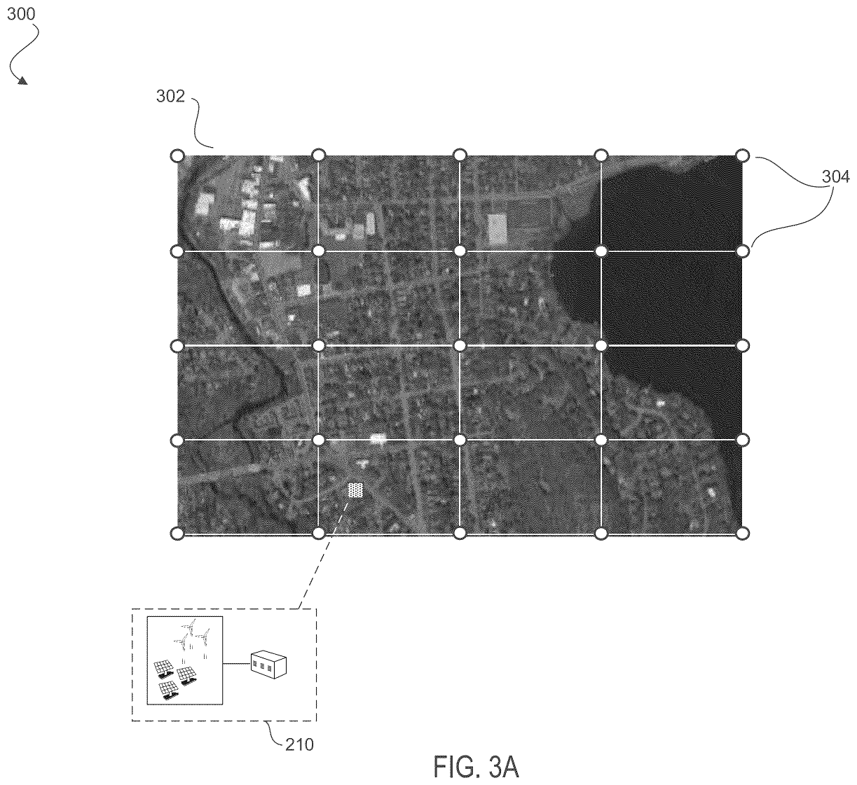

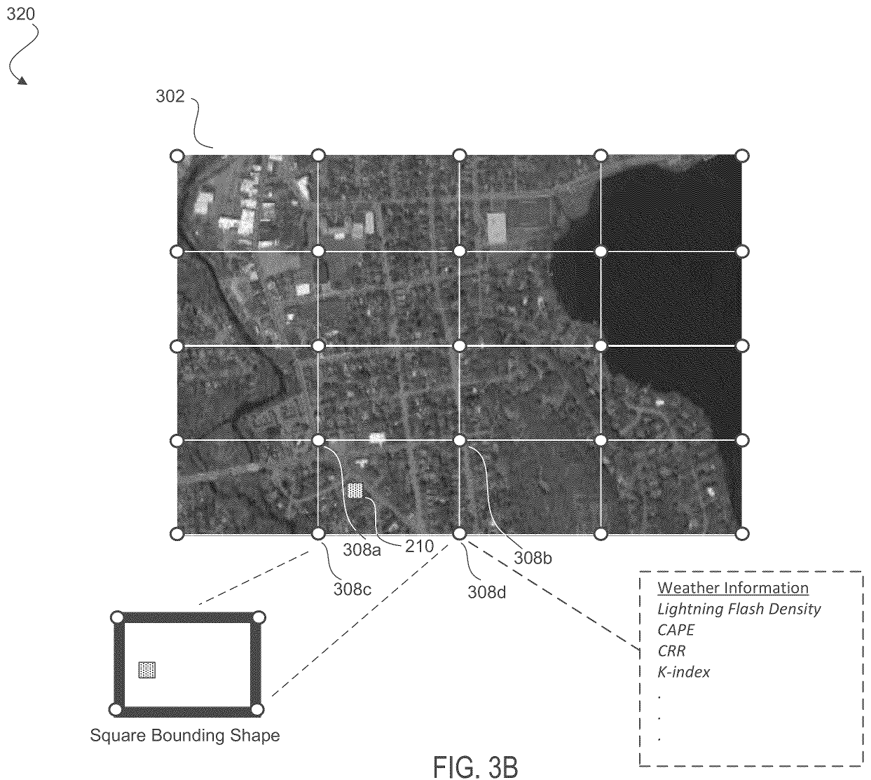

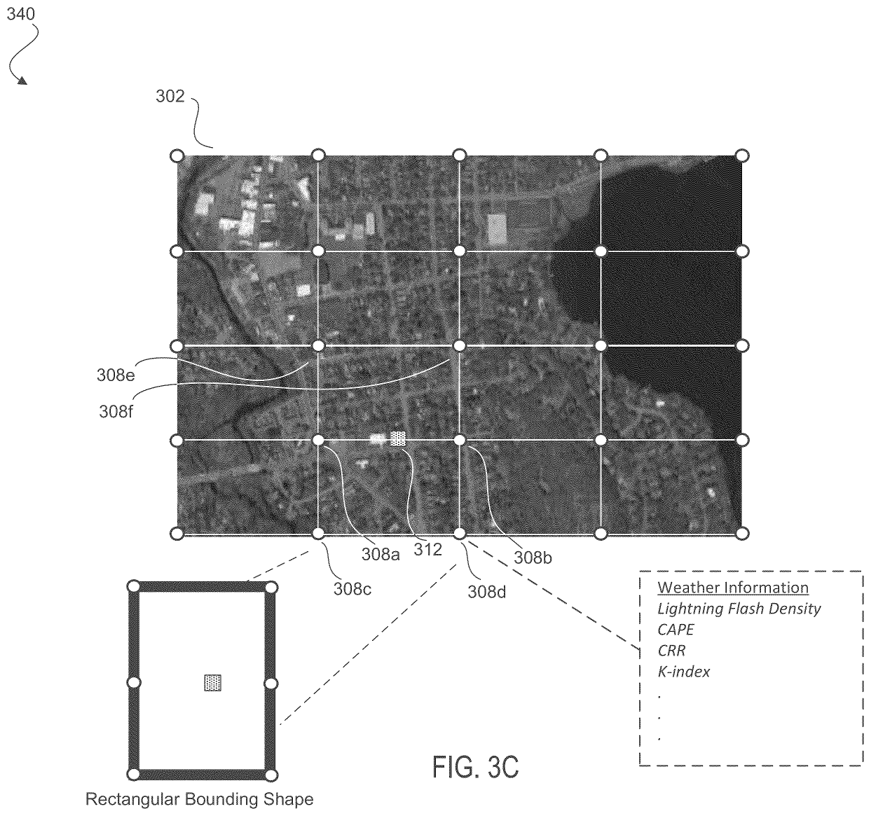

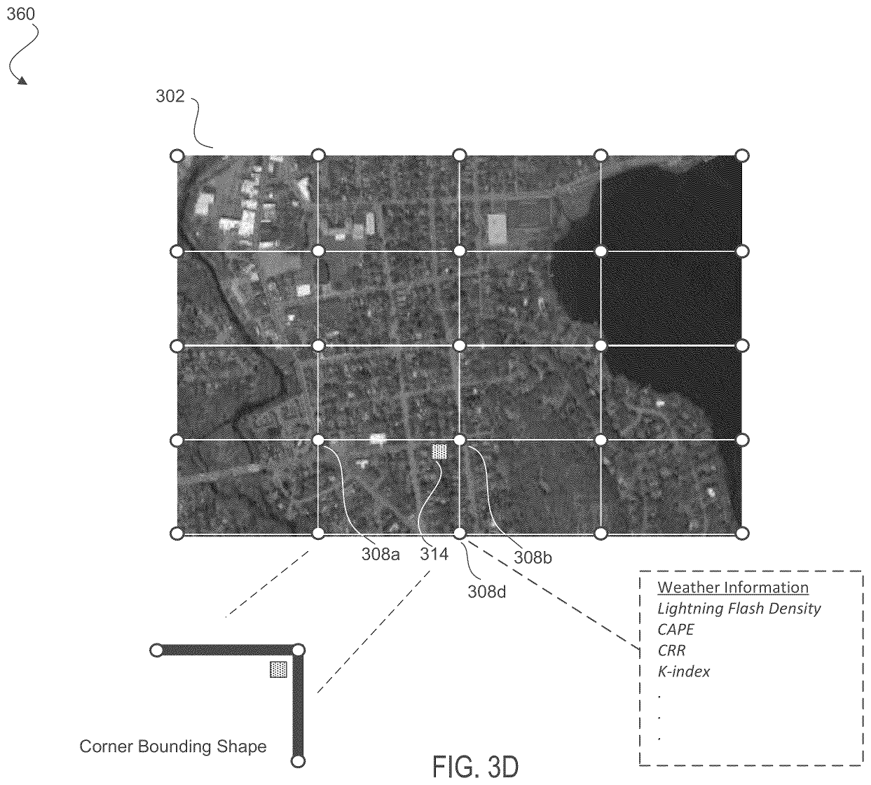

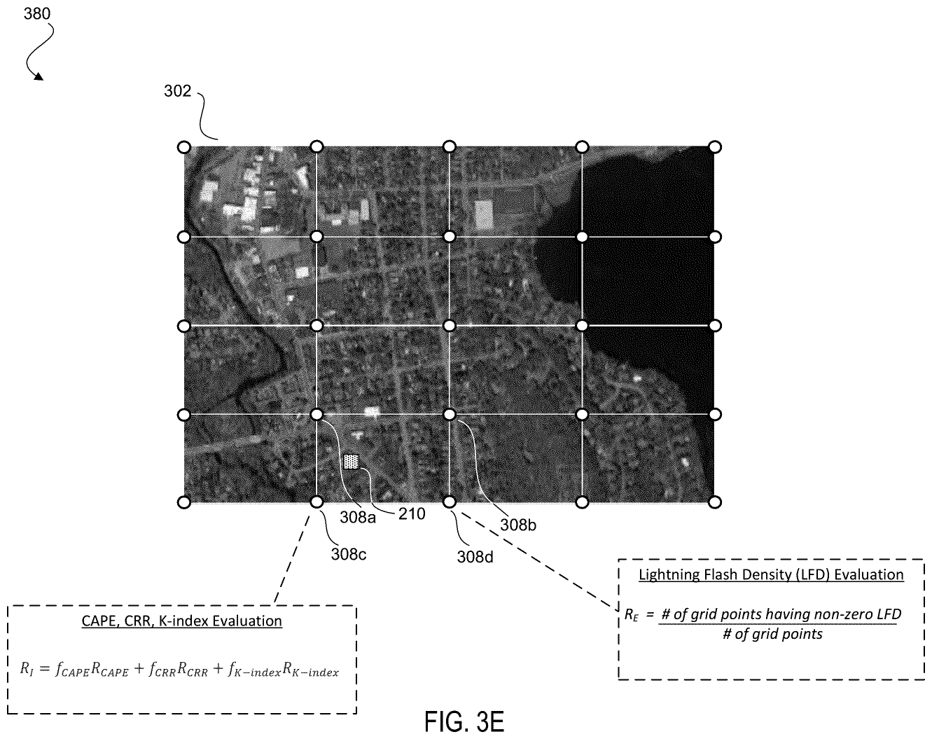

For example, the weather information obtained by the data module 254 for the geographic site 210 may provide various weather-related metrics as a grid-based representation of a weather map 302 that includes the geographic site 210, as illustrated in the example 300 of FIG. 3A. In this example, each grid point 304 may be associated with any number of weather-related metrics as predicted by a weather model, such as the HRES model. For example, each grid point 304 may be associated with weather-related metrics that include atmospheric predictions, such as temperature, wind speed and direction, humidity, and surface pressure. As another example, the weather information may include forecasts for different types of precipitation, distinguishing between rain, snow, and ice, and predictions on an amount and timing of precipitation. As further examples, the weather information may include cloud information (e.g., cloud type, altitude, etc.), ocean and sea variables (e.g., temperatures, ocean currents, etc.), and tropospheric and stratospheric data, including lightning flash density, CAPE, CRR, and K-index values.

When assessing a geographic site for lightning activity, the assessment module 256 may obtain weather-related metrics associated with a set grid points 304 that are identified based on some criteria.

For example, in some embodiments, the assessment module 256 may determine some number of grid points (e.g., three, four, five, etc.) that are within a threshold distance (or radius) of the geographic site. In this example, the assessment module 256 may evaluate weather-related metrics associated with grid points that satisfy the threshold distance to assess lightning activity for the geographic site.

As another example, in some embodiments, to assess the geographic site 210 for lightning activity, the assessment module 256 may obtain weather-related metrics associated with a set of grid points that surround (or encompass) the geographic site. For example, the assessment module 256 may obtain weather-related metrics associated with a set of grid points that form (or bound) a square shape around the geographic site 210. In this example, the set of grid points may include a first grid point 308a, a second grid point 308b, a third grid point 308c, and a fourth grid point 308d, as illustrated in the example 320 of FIG. 3B. Each of the grid points may be associated with corresponding weather-related metrics as predicted by a weather model, such as the HRES model. In various embodiments, the weather-related metrics obtained by the assessment module 256 may include, for each of the grid points, lightning flash density values, CAPE values, CRR, and K-index values associated with that grid point.

The number and selection of grid points used to evaluate a geographic site may vary depending on the geographic location of the site relative to the grid points. In some embodiments, when assessing a geographic site located between a pair of grid points, the assessment module 256 may evaluate weather-related metrics of additional grid points. For example, as shown in the example 340 of FIG. 3C, a geographic site 312 is located between a pair of grid points 308a and 308b. In this example, the assessment module 256 may evaluate weather-related metrics of additional nearby grid points 308e and 308f that form a rectangular shape around the geographic site 312. Many variations are possible.

In some embodiments, when assessing a geographic site located nearest to a single grid point, the assessment module 256 may evaluate weather-related metrics of grid points that form a corner bounding shape. In such embodiments, the grid point corresponding to the corner of the corner bounding shape is the grid point nearest to the geographic site. For example, as shown in the example 360 of FIG. 3D, a geographic site 314 is located nearest to the grid point 308b. In this example, the assessment module 256 may evaluate weather-related metrics of grid points 308a, 308b, and 308d that form the corner bounding shape around the geographic site 314. Again, many variations are possible.

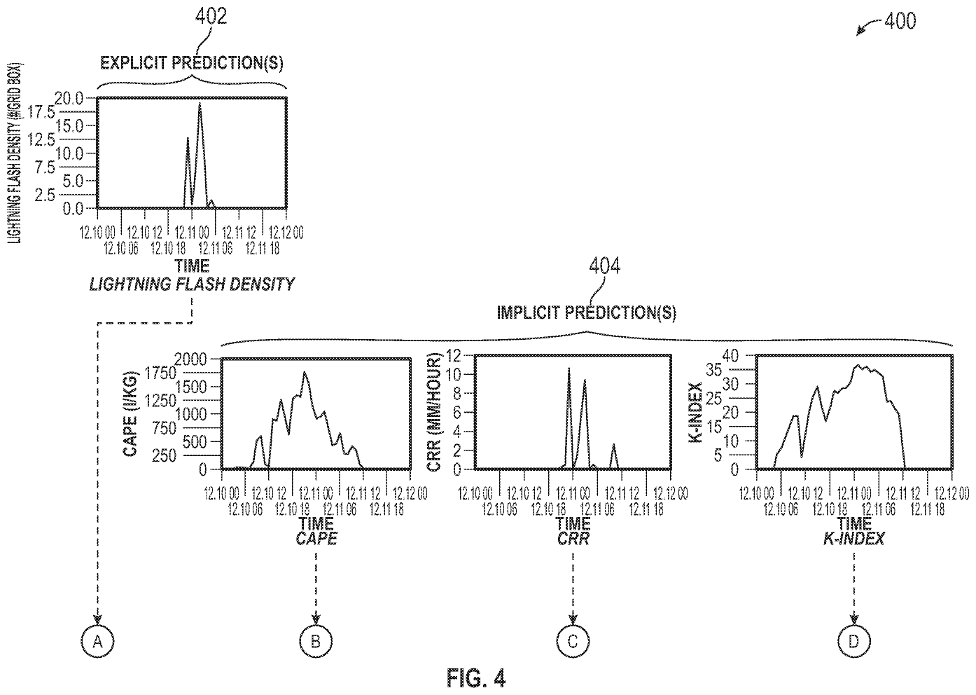

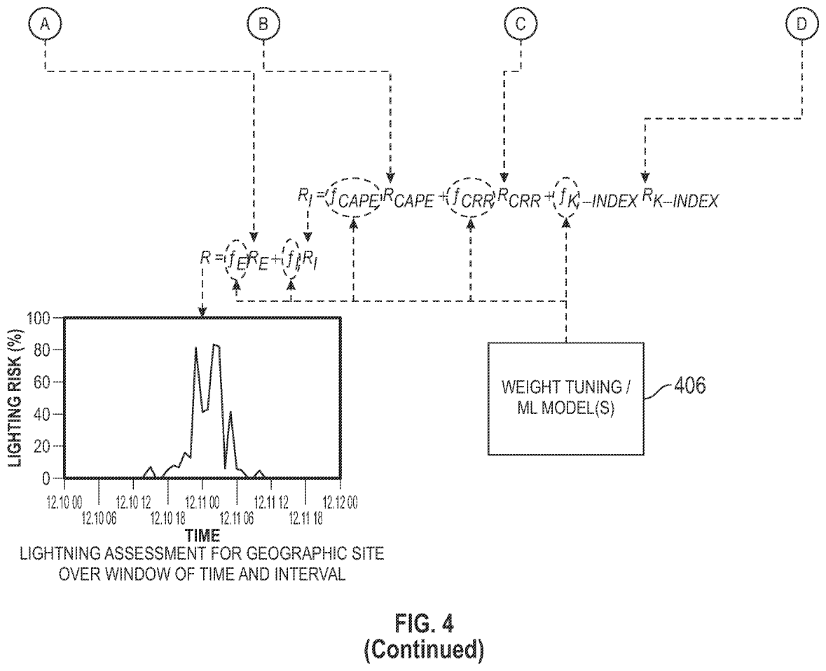

The assessment module 256 may identify (or select) grid points to assess the geographic site, for example, based on the criteria described herein. Continuing with the hybrid approach for determining lightning information, the assessment module 256 may extract weather-related metrics associated with the identified grid points. The weather-related metrics may be applied in both explicit 402 and implicit 404 parts, as illustrated in the example 400 of FIG. 4. The explicit 402 and implicit 404 parts may be evaluated to predict lightning activity for the geographic site over some requested window of time and time interval.

The lightning activity prediction, R, for the geographic site may be determined based on a weighted average of the explicit, R_{E}, and implicit, R_{I}, parts according to the following equation:

$$R = {f}_{E} {R}_{E} + {f}_{I} {R}_{I} .$$

The explicit part, R_{E}, is determined by lightning flash density values predicted by a weather model, such as the HRES model. Due to the numerical phase error embedded in the numerical schemes used in NWP models, the position of mesoscale weather boundary may be uncertain and difficult to predict, especially in coarse grid weather models, such as the HRES model. Thus, to determine the explicit part, the assessment module 256 evaluates a fractional number of grid points surrounding a geographic site for which non-zero lightning flash density values were predicted by the weather model. The greater the number of surrounding grid points with non-zero lightning flash density predictions, the higher the risk of lightning occurring at the geographic site.

For example, as shown in the example 380 of FIG. 3E, for the geographic site 210, the assessment module 256 may evaluate grid points that were identified (or selected) for the geographic site 210, e.g., the first grid point 308a, the second grid point 308b, the third grid point 308c, and the fourth grid point 308d, all of which form the square bounding shape around the geographic site 210. The assessment module 256 may determine the number of grid points that are associated with a non-zero lightning flash density value. In this example, three grid points out of a total of four grid points may have a non-zero lightning flash density value. The assessment module 256 may then determine the explicit part, R_{E}, by dividing the number of grid points having a non-zero lightning flash density value by the total number of grid points identified (or selected) for the geographic site. In the foregoing example, the assessment module 256 may determine the explicit part, R_{E}, as 0.75.

Other approaches for determining the explicit part, R_{E}, are contemplated. For example, in some embodiments, the assessment module 256 may define R_{E} as 1 if all four surrounding grid points that were identified for the geographic site 210 satisfy a threshold value. Many variations are possible.

In some embodiments, the implicit part, R_{I}, comprises three contributors predicted by a weather model, such as the HRES model: (1) Convective Available Potential Energy (CAPE), (2) Convective Rain Rate (CRR), and (3) the K-index. In some embodiments, the lightning risk due to implicit contributions, R_{I}, is a weighted average of the CAPE, CRR and K-index predictions.

R_{CAPE} represents the risk due to contribution from CAPE that describes the instability of the atmosphere and may be computed from the atmospheric thermal profile using the “parcel-theory.” CAPE can be used to parameterize the updraft strength within a thunderstorm. As a CAPE value increases, there is a greater chance for convection. Typical lower and upper bounds for CAPE may respectively be 1000 J/kg and 2000 J/kg. In this example, convection is not possible when CAPE is smaller than the lower bound and convection is likely when CAPE is greater than the upper bound.

R_{CRR} represents the risk contribution from the CRR. The CRR is the amount of precipitation generated by the NWP in its convective parameterization scheme. The magnitude of CRR is proportional to the strength of the convection within a thunderstorm. A similar idea as discussed above of applying lower and upper bounds can be implemented for CRR contribution to determine a risk of lightning.

R_{K-index} represents the risk contribution from the K-index that is a traditional measure of thunderstorm potential in meteorology. The K-index harnesses vertical temperature lapse rate, moisture content of the lower atmosphere, and the vertical extent of the moist layer. The larger the magnitude of the K-index, the greater is the potential for a thunderstorm to occur. Widely scattered thunderstorms can occur, for example, when K-index is between 26 and 30. Numerous severe thunderstorms can occur when K-index is greater than 35. Similarly, value bounds may be used to determine the lightning risk contributed by K-index.

For example, as shown in the example 380 of FIG. 3E, for the geographic site 210, the assessment module 256 may have identified (or selected) the first grid point 308a, the second grid point 308b, the third grid point 308c, and the fourth grid point 308d as grid points for assessing the geographic site 210. The assessment module 256 may determine the CAPE, CRR, and K-index values for each of these grid points.

The assessment module 256 may then determine the implicit part, R_{I}, based on a sum of respective weighted averages of CAPE, CRR, and K-index values as reflected in the following equation:

$${R}_{I} = {f}_{CAPE} {R}_{CAPE} + {f}_{CRR} {R}_{CRR} + {f}_{K - index} {R}_{K - index} .$$

f_{CAPE}, f_{CRR}, and f_{K-index} are weighting factors with a sum to unity (i.e., sum to 1). The weighting factors are tunable through historical use cases (or examples). Similarly, the weighting factors f_{E} and f_{I} also have a sum to unity (i.e., sum to 1) and may be tunable based on historic use cases.

Note that it is not necessarily true that all three conditions simultaneously satisfy lightning conditions. For example, in reality, lightning and CRR may not be co-located due to the vertical tilting of the thunderstorm cells. Having a weighted average of all three implicit factors may reduce the uncertainty due to over or under prediction for lightning risk.

Different approaches may be applied to determine the CAPE, CRR, and K-index values based on the grid points identified for assessing a geographic site. In one example, the assessment module 256 assesses each of the identified grid points to determine which has the greatest CAPE, CRR or K-index, respectively and then utilizes the greatest CAPE, CRR or K-index to determine the implicit risk factors R_{CAPE}, R_{CRR}, and R_{K-index}. In some embodiments, the assessment module 256 utilizes the CAPE, CRR and K-index of an identified grid point having the greatest CAPE, CRR, and K-index (or the greatest two out of three components). In other embodiments, the assessment module 256 utilizes the greatest CAPE of all the identified grid points, the greatest CRR of all of the identified grid points, and the greatest K-index of all of the identified grid points, where each component may be from the same or different grid points.

In another example, the assessment module 256 may average the CAPE of the identified grid points to determine the CAPE used in the above function (e.g., R_{CAPE}). Similarly, the assessment module 256 may average the CRR of the identified grid points to determine the CRR used in the above function (e.g., R_{CRR}). As follows, the assessment module 256 may average the K-index of the identified grid points to determine the K-index used in the above function (e.g., R_{K-index}). In some embodiments, the assessment module 256 may utilize the median of the CAPE, median of the CRR, and median of the K-index of the identified grid points.

It will be appreciated that the assessment module 256 may determine the applicable CAPE, CRR, and K-index in any number of ways and each may be determined in different ways. The CAPE, for example, may be a function of all or a subset of the closest grid points to the geographic site. In another example, the geographic landscape associated with different grid points closest to the geographic site and/or historical measurements may weight a convection measurement differently. For example, for a given grid point, the CAPE value may be weighted more significantly than CAPE values of other identified/selected grid points.

The notification module 258 may be configured to perform various operations. In some embodiments, the notification module 258 may provide a weather monitoring platform through which end-users, such as an operator of the geographic site 210, may access weather and lightning information.

The notification module 258 may provide interfaces (e.g., graphical user interfaces, application programming interfaces, etc.) that allow end-users to access such information for any given geographic site. The interfaces may also be used to provide alerts and/or instructions when the geographic site has a threshold likelihood of experiencing lightning strikes.

In some embodiments, the notification module 258 may be configured to perform various operations depending on lightning activity predictions, R, determined for a geographic site. For example, the lightning activity prediction, R, may be a number between 0 and 1 which represents a likelihood of lightning strikes occurring at the geographic site. Multiple lightning activity predictions, R, may be computed based on a specified window of time (e.g., 5-day window, 10-day window, etc.) and time interval (e.g., hourly, daily, etc.). In some embodiments, if the lightning activity prediction, R, for a given day and time satisfies a threshold value (e.g., greater than 0, 0.5, 0.8, etc.), the notification module 258 may electronically send a lightning alert to a computing system associated with the geographic site. The lightning alerts may provide sufficient notice to allow such end-users to take precautions to avoid or mitigate damage that may occur to infrastructure and/or operations due to anticipated lightning activity.

In some embodiments, the notification module 258 may be configured to provide shutdown instructions to computing systems of geographic sites having a threshold likelihood of experiencing lightning strikes. For example, the notification module 258 may provide shutdown instructions to a computing system associated with a geographic site. In response to the shutdown instructions, the computing system associated with the geographic site may be configured to automatically initiate procedures to shut down infrastructure to avoid or mitigate damage that may occur due to lightning activity. For example, based on the shutdown instructions, the computing system associated with the geographic site may shut down energy infrastructure, such as wind turbines, and related electronics to prevent or mitigate damage that may occur from an anticipated thunderstorm. Many variations are possible.

A module may be hardware, software, firmware, or any combination thereof. For example, each module may include functions performed by dedicated hardware (e.g., an Application-Specific Integrated Circuit (ASIC), a Field Programmable Gate Array (FPGA), or the like), software, instructions maintained in ROM, and/or any combination.

While FIG. 2B depicts a variety of different modules, it will be appreciated that the lightning predictor system 206 may include more or fewer modules. Each module may perform one or more functions of any other module.

The data store 270 may store historical weather and lightning information for geographic sites throughout the world. The historical weather and lightning information may include, for a given geographic site, location details, grid posts used to assess the geographic site, respective lightning flash density, CAPE, CRR, and K-index values, the lightning activity prediction, R, timestamp details, and an indication of whether lightning activity experienced at the geographic site was consistent with the lightning activity prediction R.

The historical weather and lightning information may be used to generate training examples for training various machine learning models 406. For example, a machine learning model may be trained to identify/select grid points best suited to assess a given geographic site based on a location of the geographic site relative to the grid points. In another example, a machine learning model may be trained to determine values for weighting factors f_{CAPE}, f_{CRR}, and f_{K-index}, as well as weighting factors f_{E} and f_{I}, to improve lightning prediction accuracy. For example, the machine learning model may weigh weather-related metrics that are most indicative of lightning activity occurring at a geographic site higher than weather-related metrics that are less indicative of lightning activity occurring at the geographic site. In this example, the weighting factors may be tuned based on whether lightning activity experienced at the geographic site was consistent with the lightning activity prediction R.

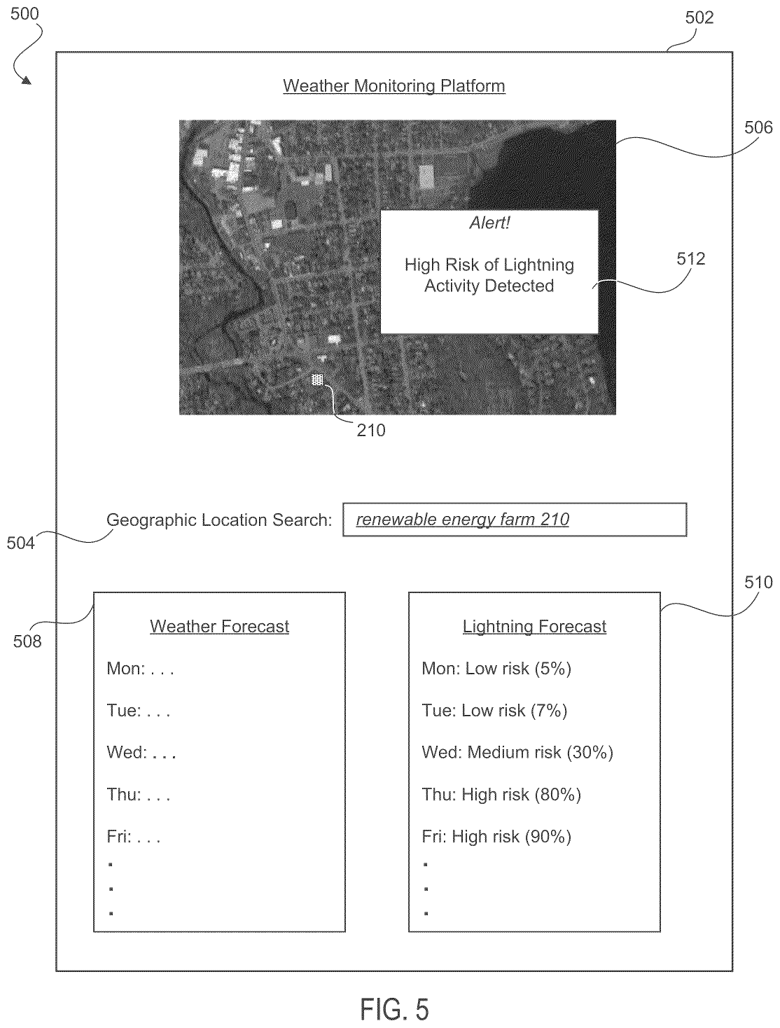

FIG. 5 illustrates an example 500 of an interface 502 (e.g., a graphical user interface) for a weather platform that may be provided by a computing system, such as the weather alert system 204 and/or the lightning predictor system 206.

The interface 502 may provide various weather and lightning information (e.g., metrics, forecasts, predictions, alerts, etc.). The interface 502 may include a search feature 504 which allows an end-user to search for weather and lightning forecasts associated with a given geographic site. For example, the end-user may search for a geographic site based on geographic coordinates, address, or site name.

In the example of FIG. 5, the end-user has searched for the geographic site 210. In response, the interface 502 provides a visual weather map 506 corresponding to the geographic site 210.

The interface 502 may also provide various weather information 508 corresponding to the geographic site 210. The weather information may include various weather-related forecasts for the geographic site 210 over some window of time and time interval. For example, the weather information may include atmospheric predictions, such as temperature, wind speed and direction, humidity, and surface pressure. As another example, the weather information may include forecasts for different types of precipitation, distinguishing between rain, snow, and ice, and predictions on an amount and timing of precipitation. As further examples, the weather information may include cloud information (e.g., cloud type, altitude, etc.), ocean and sea variables (e.g., temperatures, ocean currents, etc.), and tropospheric and stratospheric data.

The interface 502 may also provide various lightning information 510 corresponding to the geographic site 210. The lightning information may include various lightning-related forecasts for the geographic site 210 over some window of time and time interval, such as a numerical likelihood of lightning activity occurring at the geographic site 210 and/or a respective categorization of that likelihood (e.g., low risk, medium risk, high risk, etc.). Many variations are possible.

The interface 502 may be configured to generate and provide alerts related to lightning activity. For example, the interface 502 may provide a lightning alert 512 when a threshold level of lightning activity is anticipated for the geographic site 210. Many variations are possible.

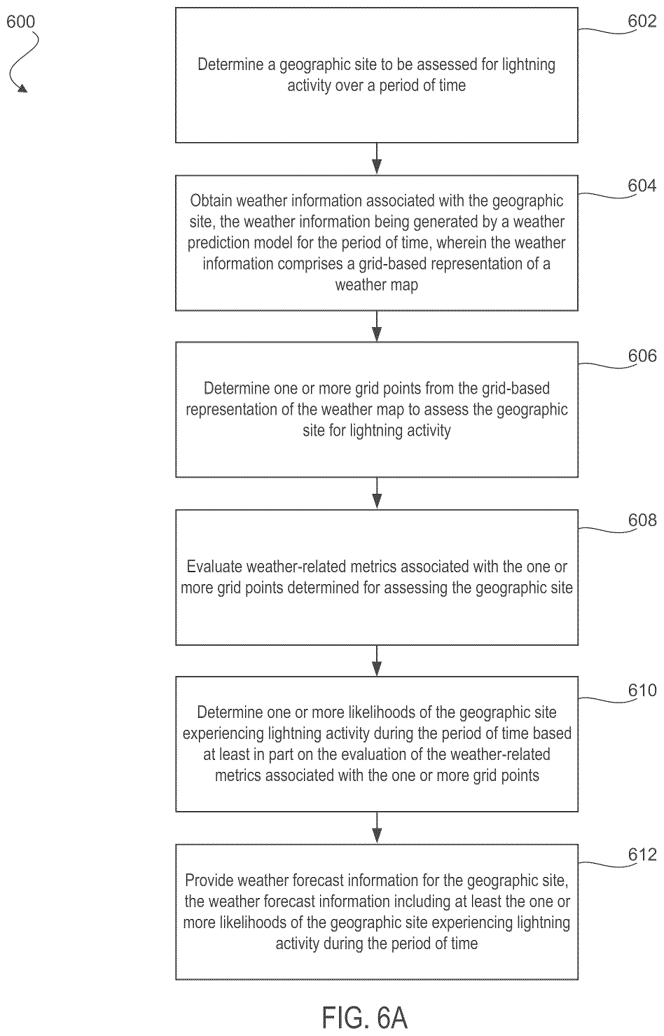

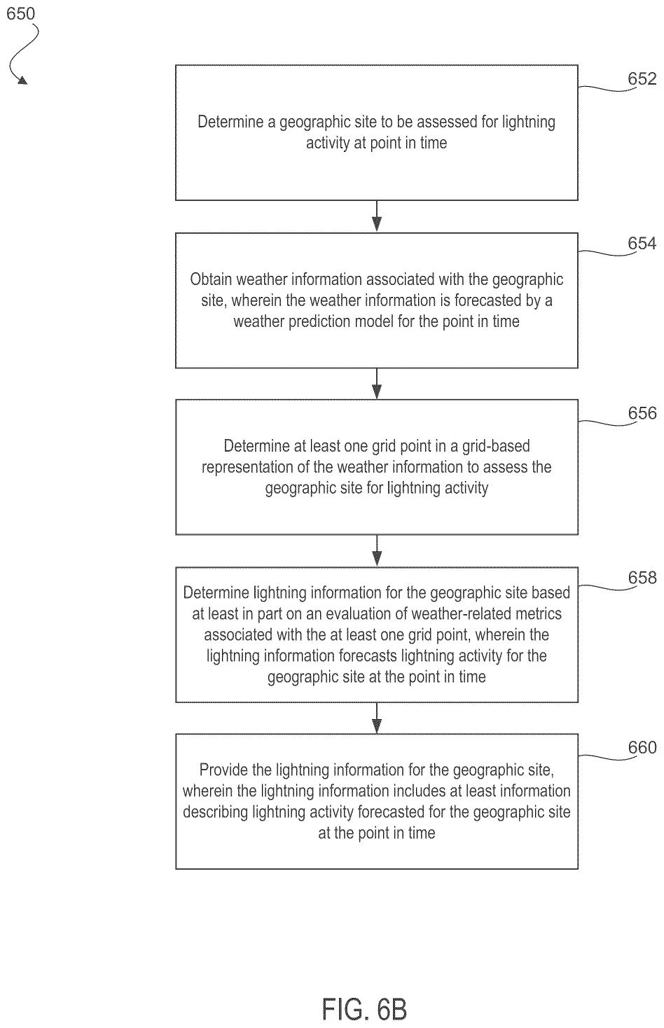

FIG. 6A illustrates an example process according to some embodiments. In step 602, a geographic site to be assessed for lightning activity over a period of time is determined. In step 604, weather information associated with the geographic site is obtained. The weather information may be generated by a weather prediction model for the period of time. The weather information may comprise a grid-based representation of a weather map. Further, grid points in the grid-based representation of the weather map may be associated with respective weather-related metrics generated by the weather prediction model. In step 606, one or more grid points from the grid-based representation of the weather map are determined for assessing the geographic site for lightning activity. In step 608, weather-related metrics associated with the one or more grid points determined for assessing the geographic site are evaluated. In step 610, one or more likelihoods of the geographic site experiencing lightning activity during the period of time are determined based at least in part on the evaluation of the weather-related metrics associated with the one or more grid points. In step 612, weather forecast information for the geographic site is provided. The weather forecast information may include at least the one or more likelihoods of the geographic site experiencing lightning activity during the period of time. Many variations are possible, as described herein.

FIG. 6B illustrates another example process according to some embodiments. In step 652, a geographic site to be assessed for lightning activity at point in time is determined. In step 654, weather information associated with the geographic site is obtained. The weather information is forecasted by a weather prediction model for the point in time. In step 656, at least one grid point in a grid-based representation of the weather information is determined to assess the geographic site for lightning activity. In step 658, lightning information for the geographic site is determined based at least in part on an evaluation of weather-related metrics associated with the at least one grid point. The lightning information forecasts lightning activity for the geographic site at the point in time. In step 660, the lightning information for the geographic site is provided. The lightning information may include at least information describing lightning activity forecasted for the geographic site at the point in time.

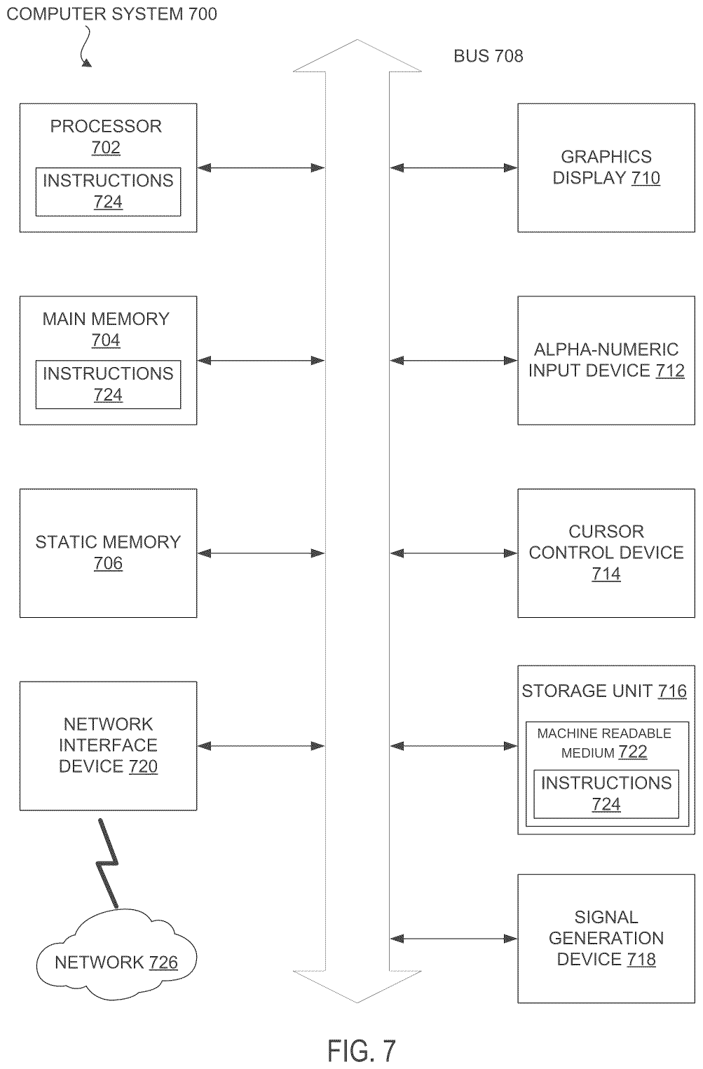

FIG. 7 is a block diagram illustrating a digital device in one example. The digital device may read instructions from a machine-readable medium and execute those instructions by a processor to perform the machine processing tasks discussed herein, such as the engine operations discussed above. Specifically, FIG. 7 shows a diagrammatic representation of a machine in the example form of a computer system 700 within which instructions 724 (e.g., software) for causing the machine to perform any one or more of the methodologies discussed herein may be executed. In alternative embodiments, the machine operates as a standalone device or may be connected (e.g., networked) to other machines, for instance, via the Internet. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes a processor 702 (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 704, and a static memory 706, which are configured to communicate with each other via a bus 708. The computer system 700 may further include a graphics display unit 710 (e.g., a plasma display panel (PDP), a liquid crystal display (LCD), a projector, or a cathode ray tube (CRT)). The computer system 700 may also include alphanumeric input device 712 (e.g., a keyboard), a cursor control device 714 (e.g., a mouse, a trackball, a joystick, a motion sensor, or other pointing instrument), a data store 716, a signal generation device 718 (e.g., a speaker), and a network interface device 720, which also is configured to communicate via the bus 708.

The data store 716 includes a machine-readable medium 722 on which is stored instructions 724 (e.g., software) embodying any one or more of the methodologies or functions described herein. The instructions 724 (e.g., software) may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 (e.g., software) may be transmitted or received over a network 726 via network interface 720.

While machine-readable medium 722 is shown in an example embodiment to be a single medium, the term “machine-readable medium” should be taken to include a single medium or multiple media (e.g., a centralized or distributed database, or associated caches and servers) able to store instructions (e.g., instructions 724). The term “machine-readable medium” shall also be taken to include any medium that is capable of storing instructions (e.g., instructions 724) for execution by the machine and that cause the machine to perform any one or more of the methodologies disclosed herein. The term “machine-readable medium” includes, but should not be limited to, data repositories in the form of solid-state memories, optical media, and magnetic media.

In this description, the term “engine” refers to computational logic for providing the specified functionality. An engine can be implemented in hardware, firmware, and/or software. Where the engines described herein are implemented as software, the engine can be implemented as a standalone program, but can also be implemented through other means, for example as part of a larger program, as any number of separate programs, or as one or more statically or dynamically linked libraries. It will be understood that the named engines described herein represent one embodiment, and other embodiments may include other engines. In addition, other embodiments may lack engines described herein and/or distribute the described functionality among the engines in a different manner. Additionally, the functionalities attributed to more than one engine can be incorporated into a single engine. In an embodiment where the engines as implemented by software, they are stored on a computer readable persistent storage device (e.g., hard disk), loaded into the memory, and executed by one or more processors as described above in connection with FIG. 7. Alternatively, hardware or software engines may be stored elsewhere within a computing system.

As referenced herein, a computer or computing system includes hardware elements used for the operations described here regardless of specific reference in FIG. 7 to such elements, including, for example, one or more processors, high-speed memory, hard disk storage and backup, network interfaces and protocols, input devices for data entry, and output devices for display, printing, or other presentations of data. Numerous variations from the system architecture specified herein are possible. The entities of such systems and their respective functionalities can be combined or redistributed.

1. A computer-implemented method comprising:
determining a geographic site to be assessed for lightning activity over a period of time;
obtaining weather information associated with the geographic site, the weather information being generated by a weather prediction model for the period of time, wherein the weather information comprises a grid-based representation of a weather map, and wherein grid points in the grid-based representation of the weather map are associated with respective weather-related metrics generated by the weather prediction model;
determining one or more grid points from the grid-based representation of the weather map to assess the geographic site for lightning activity;
evaluating weather-related metrics associated with the one or more grid points determined for assessing the geographic site;
determining one or more likelihoods of the geographic site experiencing lightning activity during the period of time based at least in part on the evaluation of the weather-related metrics associated with the one or more grid points; and
providing weather forecast information for the geographic site, the weather forecast information including at least the one or more likelihoods of the geographic site experiencing lightning activity during the period of time.

2. The computer-implemented method of claim 1, wherein weather-related metrics associated with a grid point in the grid-based representation of the weather map are predicted by the weather prediction model for a geographic location corresponding to the grid point, and wherein the weather-related metrics include at least one of: one or more lightning flash density values predicted for the grid point, one or more Convective Available Potential Energy (CAPE) values predicted for the grid point, one or more Convective Rain Rate (CRR) values predicted for the grid point, or one or more K-index values predicted for the grid point.

3. The computer-implemented method of claim 1, wherein determining the one or more grid points from the grid-based representation of the weather map to assess the geographic site for lightning activity comprises:
identifying one or more grid points in the grid-based representation of the weather map that are positioned within a threshold distance of the geographic site.

4. The computer-implemented method of claim 1, wherein determining the one or more grid points from the grid-based representation of the weather map to assess the geographic site for lightning activity comprises:
determining a plurality of grid points in the grid-based representation of the weather map that encompass the geographic site based at least in part on a bounding shape.

5. The computer-implemented method of claim 1, wherein evaluating weather-related metrics associated with the one or more grid points determined for assessing the geographic site comprises:
determining an explicit prediction based at least in part on weather-metrics associated with the one or more grid points determined for assessing the geographic site for lightning activity, the explicit prediction being based at least in part on lightning flash density values associated with the one or more grid points; and
determining an implicit prediction based at least in part on weather-metrics associated with the one or more grid points determined for assessing the geographic site for lightning activity, the implicit prediction being based at least in part on one or more of: Convective Available Potential Energy (CAPE) values associated with the one or more grid points determined for assessing the geographic site, Convective Rain Rate (CRR) values associated with the one or more grid points determined for assessing the geographic site, or K-index values associated with the one or more grid points determined for assessing the geographic site.

6. The computer-implemented method of claim 5, wherein the explicit prediction is calculated as a fraction with a numerator that corresponds to a count of grid posts in the one or more grid posts that have a non-zero lightning flash density value and a denominator that corresponds to a total count of grid posts in the one or more grid posts.

7. The computer-implemented method of claim 5, wherein the implicit prediction is calculated as a weighted average of at least one of: Convective Available Potential Energy (CAPE) values associated with the one or more grid points determined for assessing the geographic site, Convective Rain Rate (CRR) values associated with the one or more grid points determined for assessing the geographic site, or K-index values associated with the one or more grid points determined for assessing the geographic site.

8. The computer-implemented method of claim 5, wherein a likelihood of the geographic site experiencing lightning activity during the period of time is calculated as a weighted average of one or more values associated with the explicit prediction and one or more values associated with the implicit prediction.

9. The computer-implemented method of claim 1, wherein providing weather forecast information for the geographic site comprises:
determining that at least one of the one or more likelihoods of the geographic site experiencing lightning activity during the period of time satisfy a threshold likelihood value; and
providing an alert to a computing system associated with the geographic site in response to the determination.

10. The computer-implemented method of claim 1, wherein providing weather forecast information for the geographic site comprises:
providing a graphical user interface corresponding to a weather monitoring platform, the graphical user interface including at least: a visual map of the geographic site and lightning information determined for the geographic site.

11. A computer-implemented method comprising:
determining a geographic site to be assessed for lightning activity at point in time;
obtaining weather information associated with the geographic site, wherein the weather information is forecasted by a weather prediction model for the point in time;
determining at least one grid point in a grid-based representation of the weather information to assess the geographic site for lightning activity;
determining lightning information for the geographic site based at least in part on an evaluation of weather-related metrics associated with the at least one grid point, wherein the lightning information forecasts lightning activity for the geographic site at the point in time; and
providing lightning information for the geographic site, wherein the lightning information includes at least information describing lightning activity forecasted for the geographic site at the point in time.

12. The computer-implemented method of claim 11, wherein determining at least one grid point in a grid-based representation of the weather information to assess the geographic site for lightning activity comprises:
identifying one or more grid points in the grid-based representation of the weather information that are positioned within a threshold distance of the geographic site.

13. The computer-implemented method of claim 11, wherein determining at least one grid point in a grid-based representation of the weather information to assess the geographic site for lightning activity comprises:
determining a plurality of grid points in the grid-based representation of the weather information that bound the geographic site based at least in part on a bounding shape.

14. The computer-implemented method of claim 11, wherein determining lightning information for the geographic site comprises:
determining a likelihood of lightning activity occurring at the geographic site at the point in time based at least in part on an evaluation of (a) lightning flash density values associated with the at least one grid point at the point in time, (b) Convective Available Potential Energy (CAPE) values associated with the at least one grid point at the point in time; (c) Convective Rain Rate (CRR) values associated with the at least one grid point at the point in time, or (d) K-index values associated with the at least one grid point at the point in time, or a combination thereof.

15. The computer-implemented method of claim 14, wherein the lightning information includes the likelihood of lightning activity occurring at the geographic site at the point in time.

16. A system comprising at least one processor and memory storing instructions that cause the system to perform:
determining a geographic site to be assessed for lightning activity at point in time;
obtaining weather information associated with the geographic site, wherein the weather information is forecasted by a weather prediction model for the point in time;
determining at least one grid point in a grid-based representation of the weather information to assess the geographic site for lightning activity;
determining lightning information for the geographic site based at least in part on an evaluation of weather-related metrics associated with the at least one grid point, wherein the lightning information forecasts lightning activity for the geographic site at the point in time; and
providing lightning information for the geographic site, wherein the lightning information includes at least information describing lightning activity forecasted for the geographic site at the point in time.

17. The system of claim 16, wherein, when determining at least one grid point in a grid-based representation of the weather information to assess the geographic site for lightning activity, the system performs:
identifying one or more grid points in the grid-based representation of the weather information that are positioned within a threshold distance of the geographic site.

18. The system of claim 16, wherein, when determining at least one grid point in a grid-based representation of the weather information to assess the geographic site for lightning activity, the system performs:
determining a plurality of grid points in the grid-based representation of the weather information that bound the geographic site based at least in part on a bounding shape.

19. The system of claim 16, wherein, when determining lightning information for the geographic site, the system performs:
determining a likelihood of lightning activity occurring at the geographic site at the point in time based at least in part on an evaluation of (a) lightning flash density values associated with the at least one grid point at the point in time, (b) Convective Available Potential Energy (CAPE) values associated with the at least one grid point at the point in time; (c) Convective Rain Rate (CRR) values associated with the at least one grid point at the point in time, or (d) K-index values associated with the at least one grid point at the point in time, or a combination thereof.

20. The system of claim 16, wherein the lightning information includes the likelihood of lightning activity occurring at the geographic site at the point in time.
